(19) United States
(12) Patent Application Publication
(10) Pub. No.: US 2022/0268940 A1
(43) Pub. Date: Aug. 25, 2022

(54) OPTICAL OBJECT DETECTION AND CLASSIFICATION WITH DYNAMIC BEAM CONTROL

(71) Applicant: LENSVECTOR INC., San Jose, CA (US)

(72) Inventor: Tigran GALSTIAN, Québec (CA)

(21) Appl. No.: 17/632,812

(22) PCT Filed: Aug. 7, 2020
(86) PCT No.: PCT/CA2020/051085

§ 371 Date: Feb. 4, 2022

Related U.S. Application Data
(60) Provisional application No. 62/883,770, filed on Aug. 7, 2019.

(51) Int. Cl. G01S 17/89; G01B 11/24; G01S 7/484

(52) U.S. Cl. CPC G01S 17/89; G01B 11/24; G01S 7/484

(57) ABSTRACT

An optical object detection device and method using a light emitter and a detector sensitive to reflected light from an object is described herein. The object detection device includes a liquid crystal beam shaping element to allow beam steering, broadening and diffraction of the light emitter. The detection of the object may be done through analyzing the reflected light from different degrees of broadening of the light emitter's beam. The localization and/or the shape of the object may further be determined by analyzing the reflected light from a grid pattern obtained through diffracting the light emitter's beam.

### CROSS-REFERENCE TO RELATED APPLICATIONS

This application claims priority from U.S. Provisional Patent Application 62/883,770 filed Aug. 7, 2019, the contents of which are hereby incorporated by reference.

### TECHNICAL FIELD

This patent application relates to optical object detection, such as proximity sensing.

### BACKGROUND

Optical object detection involving a light emitter and a detector sensitive to reflected light from an object for sensing or detecting the presence of the object is well known in the art. The choice of optical wavelength can vary according to the needs, for example visible or invisible. The choice of beam shape, such as a collimated beam that detects passage across a line, or a fan-shaped or conical beam that projects light over a given area, also varies according to the detection needs. Such active source optical object detection is commonly used in a variety of proximity sensors and for applications such as object identification, distance estimation, and 3D mapping.

### SUMMARY

Applicant has discovered that a liquid crystal dynamic beam shaping device can be coupled to a light source for enhancing optical object detection.

In some embodiments, variable liquid crystal beam shaping is used to variably broaden a narrow beam. When narrow, the beam can detect both closer and farther objects that are within the scope of the narrow beam, and when broader, the beam can detect closer objects within a wider area. Dynamically varying the beam may be used to determine information about the object's relative size and position.

A first broad aspect is a detection device including a light source for projecting a beam of light within a target region having an initial beam divergence; a light detector for receiving light reflected from an object within the target region and providing a detection signal; a liquid crystal beam shaping element having an input control signal defining a modulation of the light source beam to provide a controllable greater divergence in the beam of light within the target region; and a controller responsive to the detection signal for adjusting the input control signal to detect and analyze objects and positions of the objects with an improved signal-to-noise ratio.

In some embodiments, the liquid crystal beam shaping element includes a liquid crystal layer disposed between two substrates and two or more independent electrodes disposed on one of the substrates.

In some embodiments, the electrodes are configured to provide a spatially variable electric field.

In some embodiments, the initial beam divergence is less than 10 degrees.

In some embodiments, the beam divergence is between 2 degrees and 50 degrees.

In some embodiments, the detection device is configured to detect a distance of the object from the detection device.

In some embodiments, the light source is configured to project the beam of light in a series of pulses.

In some embodiments, the light detector is configured to use a bandpass filter to distinguish the detection signal from a noise signal.

In some embodiments, the liquid crystal beam shaping element is configured to perform at least one of the following: symmetric broadening, asymmetric light stretching, diffraction and beam steering.

In some embodiments, an automatic controller for an appliance includes one or more detection devices.

Another broad aspect is a method of performing proximity detection using a proximity sensor, the method including projecting a beam of light within a target region, the beam having an initial beam divergence and angle of projection; receiving light reflected from an object within the target region; determining a first signal-to-noise ratio; dynamically manipulating the beam of light; determining a second signal-to-noise ratio; and determining a distance of the object from the proximity sensor.

In some embodiments, manipulating the beam of light includes broadening the beam divergence of the beam of light.

In some embodiments, manipulating the beam of light includes changing the angle of projection of the beam of light.

In some embodiments, manipulating the beam of light includes using a liquid crystal element.

In some embodiments, the method of performing proximity detection using a proximity sensor further includes eliminating noise from the detected signals.

Another broad aspect is a method of determining a location and/or a shape of an object, the method including projecting a light signal with narrow spectral band; diffracting the light signal using a liquid crystal device to produce a grid pattern; acquiring an image of the grid pattern reflected by the object; and determining the location and/or a shape of the object from the grid pattern reflected by the object.

In some embodiments, the grid pattern extends in a single direction.

In some embodiments, the grid pattern extends in two directions in a single plane.

In some embodiments, the method of determining a location and/or a shape of an object further includes configuring the liquid crystal device to control a pitch of the grid pattern.

In some embodiments, controlling a pitch of the grid pattern includes producing a first grid pattern with a first pitch and a second grid pattern with a second pitch.

In some embodiments, controlling a pitch of the grid pattern includes dynamically varying the pitch.

In some embodiments, the light signal includes pulses at a given frequency.

In some embodiments, the method of determining a location and/or a shape of an object further includes controlling the liquid crystal device based on the acquired image of the reflected light.

### BRIEF DESCRIPTION OF THE DRAWINGS

The invention will be better understood by way of the following detailed description of embodiments of the invention with reference to the appended drawings, in which:

FIG. 1 is a sectional schematic view of a prior art liquid crystal beam broadening device using strip electrodes capable of performing in-plane reorientation of liquid crystal molecules;

FIG. 2 is a sectional schematic view of a liquid crystal beam steering device using in-plane strip interdigitated electrodes;

FIG. 3 is a schematic block diagram of a proximity detection device including a liquid crystal beam broadening element which is used to improve detection and obtain an estimate of object location;

FIG. 4 is a schematic illustration of beam broadening used to variably detect an object in two positions;

FIGS. 5A and 5B are flowcharts of beam broadening control;

FIG. 6 is a flowchart of beam broadening control for object location;

FIG. 7 is a schematic of an object location system;

FIGS. 8A-8B are schematic diagrams of LCD electrodes and connections;

FIGS. 9A-9D are projected light patterns;

FIGS. 10A-10B are schematic illustrations of beam broadening used to measure and to characterize objects in two positions;

FIG. 11 is a flowchart of beam broadening control using a grid; and

FIG. 12 is a flowchart of beam steering control using a grid.

### DETAILED DESCRIPTION

The current patent application aims at improving object detection and recording efficiency by providing dynamically variable lighting system.

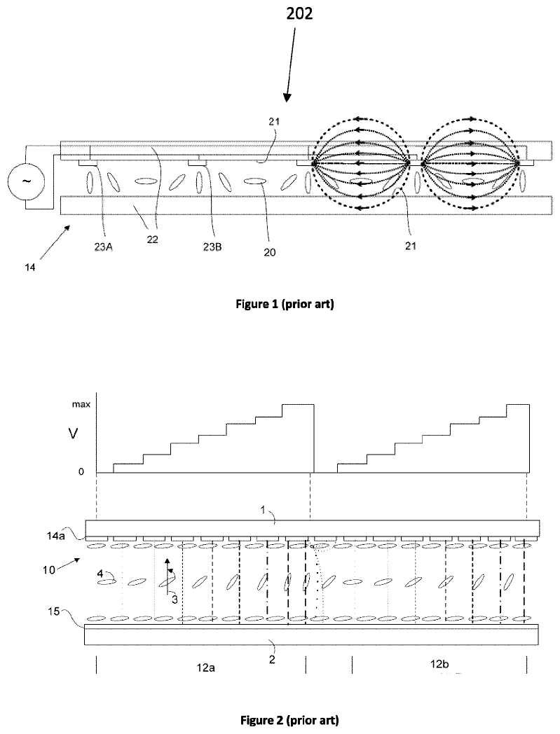

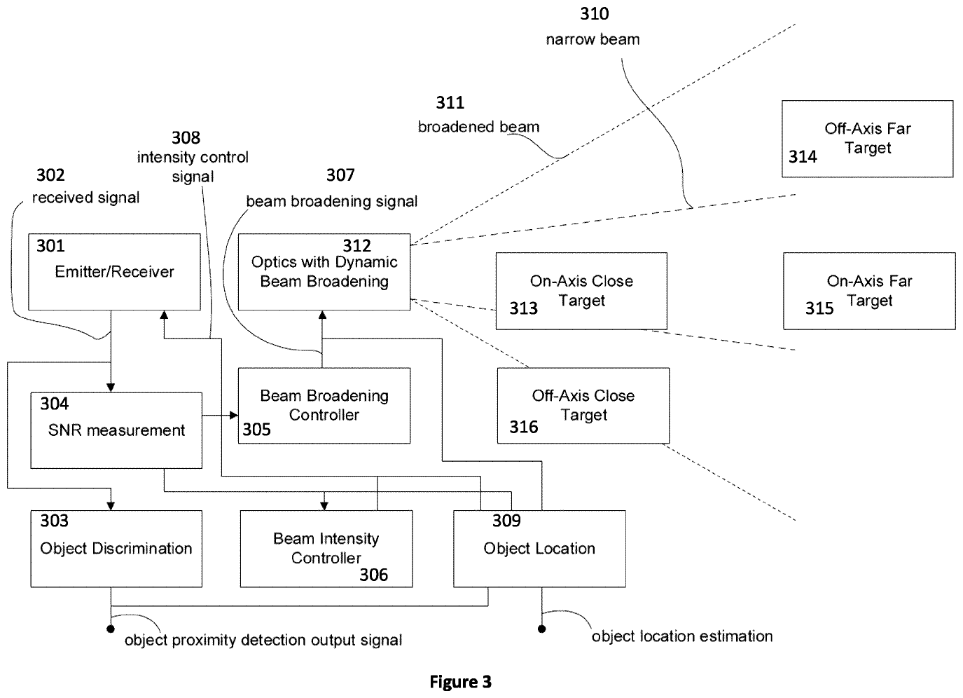

FIGS. 1 and 2 illustrate liquid crystal beam broadening and steering devices as is known in the art. Examples of beam broadening devices are known from Applicant's published patent application WO 2017/041167 dated 16 Mar. 2017. Examples of beam steering devices are known from Applicant's published patent application WO 2016/082031 dated 2 Jun. 2016. WO 2017/041167 and WO 2016/082031 are incorporated herein by reference in their entirety.

FIG. 1 shows an exemplary liquid crystal device 202. Such a liquid crystal device 202 may be used as part of an object location system in accordance with the present disclosure. FIG. 1 illustrates a liquid crystal beam control device 202 having a single liquid crystal layer 20 that has, on one (top) substrate, including an alignment layer, independent electrodes 23A and 23B separated by gaps g to provide a control electric field between electrodes 23A and 23B that is spatially variable in the volume of liquid crystal material below each gap g. When a control signal having a voltage is applied across electrodes 23A and 23B, the electric field follows a geometry oriented essentially parallel to the (separation) direction between the electrodes 23A and 23B at a midpoint of each gap g, while the orientation of the electric field lines turns to be essentially perpendicular to the (separation) direction between the electrodes 23A and 23B near (at) the edges of each gap g.

In FIG. 1, the aspect ratio (R) of the electrode spacing (g), or period between the electrodes 23A and 23B, and the thickness of the liquid crystal layer (L), R=g/L, can be, for example, between 0.7 and 4 (preferably about 2.5 for a microlens application). For simplicity, the width w of electrodes here is considered much smaller than the gap g.

FIG. 2 illustrates an exemplary beam steering liquid crystal device 10 having two zones or segments 12a and 12b. The liquid crystal material 4 is contained by substrates 1 and 2 being sealed at their edges (not shown). The electric field is provided by narrow electrodes 14a (for example arranged as strips) that are each supplied with a desired voltage and are opposite a planar electrode 15. In the embodiment shown, the electrodes are provided on the substrates inside the cell.

As is known in the art, electrodes for a transmissive liquid crystal device can be transparent, for example of a coating of indium tin oxide (ITO) material. The approximate voltage, as schematically is shown (in the inset at the top of the figure), ramps up at one side of zone 12a from a minimum value and begins again the same ramp on the other side of the zone boundary in zone 12b. The drive frequency can be the same for all of the electrodes 14a, and the liquid crystal molecules 4 orient themselves to be parallel to the electric field 3.

Further details of the devices illustrated in FIGS. 1 and 2 are provided in the applications referenced above and incorporated herein by reference. One skilled in the art will recognize that the systems disclosed herein may include the devices illustrated in FIGS. 1 and 2, any similar device, or any device that performs the same or similar function without departing from the scope of the disclosure. Similarly, the methods disclosed herein may make use of the devices illustrated in FIGS. 1 and 2, any similar devices, or any devices or combinations of devices which perform the same or similar function.

According to the present disclosure, the devices and methods described above may be used to perform proximity detection, object location and optimized recording or monitoring. Proximity detection may comprise detecting whether an object is located proximate a sensor, and object location may comprise detecting the approximate position or the distance at which an object is disposed from a sensor. Proximity detection and object location according to the present disclosure may be used in applications such as automobile sensors for intelligent control systems, automatic lights, faucets, and other appliances. The present disclosure may allow for optimized or more precise control in these and other applications by improving proximity detection and allowing object location to be performed using a proximity sensor.

A variety of types of proximity detection may be incorporated as part of the systems and methods disclosed herein. First, two types of light sources are proposed: spectrally broad band light source (e.g., LED/Phosphore) and narrow band light sources (e.g., Infra Red LED or Diode Laser). Second, three approaches for obtaining optimization are proposed: simple symmetric broadening, asymmetric light stretching, and steering elements may be used to obtain the optimization. Any light source may be used with any optimization approach. One skilled in the art will further recognize that the methods and systems disclosed herein are compatible with other types of proximity detection known in the art. Accordingly, methods and systems described herein may use any type of proximity detection without departing from the scope of the disclosure.

The present disclosure relates to methods and systems using a proximity sensor to detect and locate objects. Prior art may disclose detecting objects using proximity sensors. The present disclosure may present advantages over the prior art by providing for improved object detection by dynamic optimization of lighting (illumination) conditions and by further providing for object location using proximity sensors.

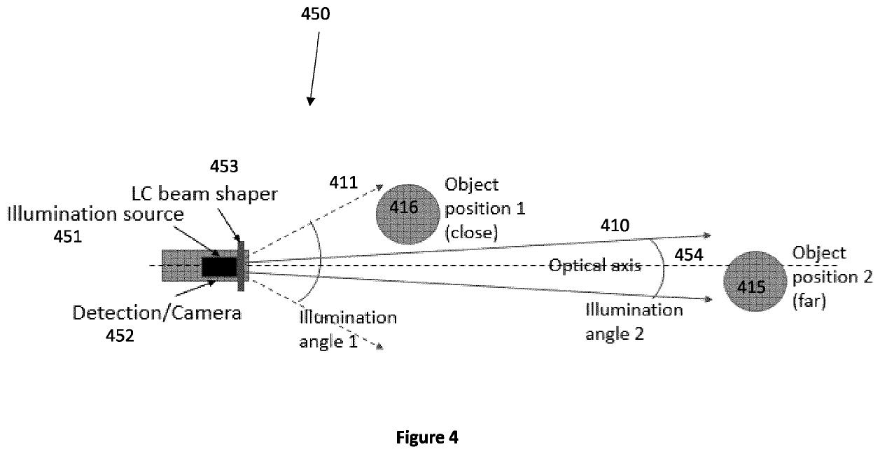

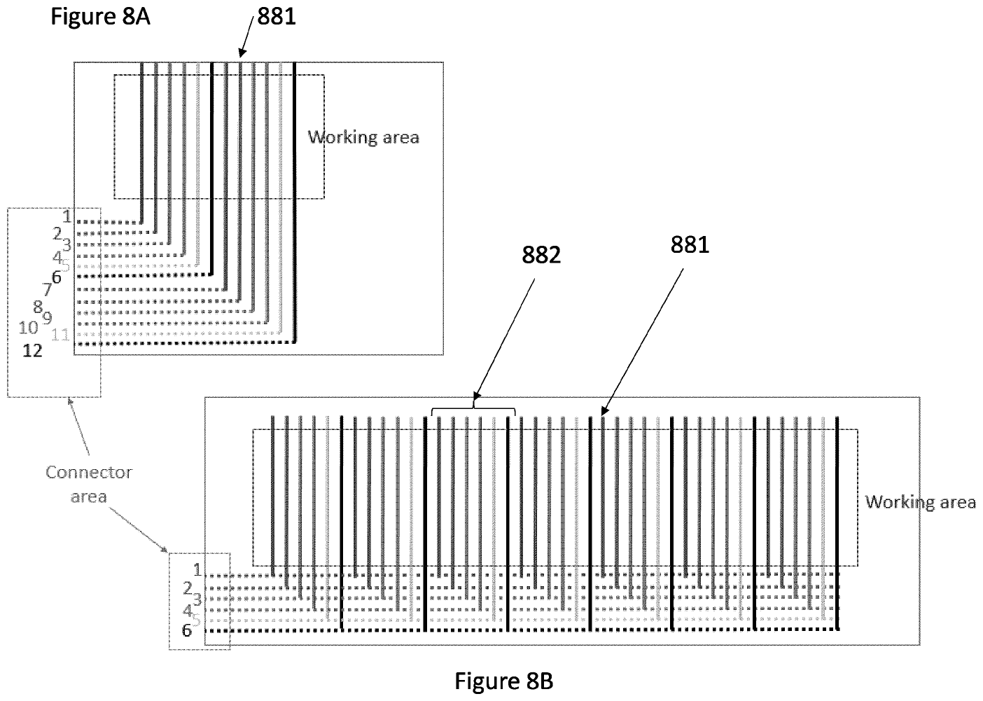

The present disclosure relates to two general categories of systems and methods. The first category is directed towards systems and methods which use a broadened or stretched beam to detect objects, locate objects, and/or determine information about objects. The second category is directed towards systems and methods which use a diffracted beam to detect objects, locate objects, and/or determine information about objects (e.g., 3D forms). In general, FIGS. 3-6 are related to the first category and FIGS. 7-12 are directed towards the second category. Some embodiments of the present disclosure may belong to both categories.

Systems and Methods Using a Broadened Beam

FIG. 3 shows a schematic detailing a method of object location and is describing corresponding hardware. The method will be outlined in general terms here, while specific embodiments will be detailed below. An emitter/receiver 301 may emit and detect a signal. The signal may be a series of pulses of light. The beam may be a conical beam, a slit beam, or any other type of beam known in the art. A conical beam may move outward from the emitter/receiver 301 with the cone having a particular angle. A slit beam may move outward from the emitter/receiver 301 in a generally slit like shape which expands laterally at a particular angle. This emitted signal cone or slit is represented by the narrow beam 310. In some embodiments, the angle may be approximately from 2.5 degrees up to 15 degrees.

The emitter/receiver 301 may capture a received signal 302. The received signal may comprise background light signal from the environment in which the emitter/receiver 301 is located. Alternatively, a spectral filter can be used to detect only (mainly) the signal emitted by 301. If an object is located in the path of the emitted signal, the received signal 302 may also comprise light emitted by the emitter/receiver 301 that is reflected from the object.

The received signal 302 may be analyzed through object discrimination 303 and/or signal-to-noise-ratio (SNR) measurement 304. Object discrimination 303 may entail determining whether an object is located in the path of the emitted signal. Performing object discrimination 303 may comprise determining whether the received signal 302 includes a reflected signal as described above. A reflected signal may have the same pulse pattern as the emitted signal and this pulse pattern may be used to recognize the reflected signal. If the received signal 302 includes a reflected signal, an object may be present; if the received signal 302 does not include a reflected signal, an object may not be present.

SNR measurement 304 may entail determining the ratio of the reflected signal (signal) to the background light signal (noise). This ratio may be defined as

$$\frac{signal}{( signal + noise )} ,$$

and may be called the SNR. If the received signal 302 is entirely noise, the SNR may be zero. If the received signal 302 is entirely reflected signal, the SNR may be one, or close to one. A high SNR may indicate that the object is occupying a large percentage of the area of a cross-section of the cone of the emitted signal. A low SNR may indicate that the object is occupying a small percentage of the area of a cross-section of the cone of the emitted signal. Obviously, we must also consider the reflectivity of the object's surface for the emitter's wavelength. Otherwise, relative measurements (e.g., change in time) can be performed. Object discrimination 303 and/or SNR measurement 304 may be performed by the emitter/receiver 301, by a separate controller (not illustrated), or by another piece of hardware. In some embodiments, calculations other than SNR measurements 304 may be performed. One skilled in the art will recognize that such measurements may be readily used with in place of SNR measurements 304.

The SNR may provide a first step in determining the object's approximate location 309 and object size. As discussed above, the SNR provides an estimation of the percentage of a cross-section of the emitted signal which an object occupies. One skilled in the art will recognize that the area of a cross-section of the signal increases with distance from the emitter/receiver 301 because of the divergence of the emitted signal. Therefore, an object which produces a large SNR may be a relatively small object located relatively close to the emitter/receiver 301 or a relatively large object located relatively far from the emitter/receiver 301. Accordingly, this first SNR merely provides a first data point for object location 309 and does not enable an object to be located precisely.

To complete object location 309, a beam broadening controller 305 and a beam intensity controller 306 may be operated based on the SNR measurement 304. The beam broadening controller 305 may produce a dynamic (or transient) beam broadening signal 307. The beam broadening signal 307 may be used to broaden the cone of the signal emitted by the emitter/receiver 301 through any beam broadening hardware and methods known in the art. This broadened emitted signal cone is represented by the broadened beam 311. In some embodiments, the beam broadening may be performed by hardware which is separate from the emitter/receiver 301. In some embodiments, the beam controller 305 may broaden the emitted signal to a cone of about 50 degrees, or to any angle between 2 degrees and 50 degrees.

The beam intensity controller 306 may produce a beam intensity signal 308, which may increase or decrease (dimming) the intensity of the emitted signal through any hardware and methods known in the art. In some embodiments, the beam intensity may be changed by the emitter/receiver 301.

Dynamic beam broadening 312 may enable optimized object location 309 to be performed for different positions of objects: e.g., on axis close targets 313, off-axis far targets 314, and on-axis far targets 315. Methods for determining the location of these objects using the narrow beam 310 and the broadened beam 311 will be described below. FIG. 3 also illustrates an off-axis close target 316. It may not be possible to measure the location of this type of object precisely because it is not located entirely within the narrow beam 310 or the broadened beam 311.

The distance of the object may vary from few centimeters to many meters. In the majority of those cases, the stationary illumination system will not be optimal since for close objects the detection (or the recording) device will be back illuminated (by the reflection of light from the object) with high intensity and will saturate the process if the object is close; while the back-scattered signal may be too weak if the object is far. The same problem can happen in many applications (Lidar detection, video or picture recording, security camera, etc.).

As illustrated in FIG. 3, an object may reflect a first percentage of the narrow beam 310 and a second percentage of the broadened beam 311. A first SNR and a second SNR may be calculated for each of these situations, as described in step 304. An on-axis close target 313 may produce a first SNR between zero and one and a second SNR between zero and one. The first SNR may be greater than the second SNR. An on-axis far target 315 may also produce a first SNR between zero and one and a second SNR between zero and one. The first SNR may be greater than the second SNR. An off-axis far target 314 may produce a first SNR of zero and a second SNR between zero and one. The second SNR may be greater than the first SNR.

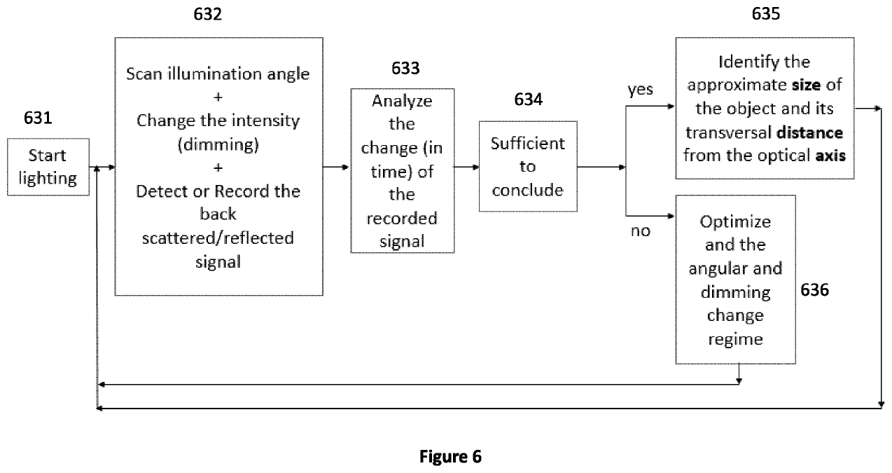

These steps may be performed iteratively as detailed in FIGS. 5A and 5B, which are discussed in detail below, to perform object detection and object location, respectively. In such methods, the beam may be broadened in incremental steps, such that the methods use one unbroadened narrow beam 310 and multiple broadened (one after the other) beams 311.

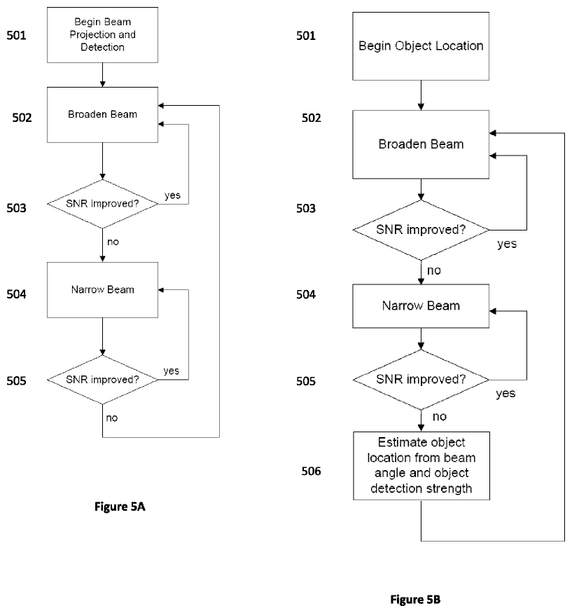

FIG. 4 provides more detailed illustrations of the hardware which may be used to perform the methods described above. FIG. 4 illustrates an object location system 450 which includes hardware which may function as the emitter/receiver described above. An illumination source 451 may emit a signal, which may comprise pulses of light (visible or infra red radiation). As shown, the light may be emitted in a conical beam. A detector/camera 452 may receive reflected light and other background light. The illumination source 451 and the detector/camera 452 may be connected to a processor (not shown) or other hardware which may calculate SNRs based on the emitted and received signals. A synchronized emitting/detection approach may be used to increase the SNR. A dynamic beam shaper 453 (LC beam shaper) may be connected to the illumination source 451, such that the beam shaper 453 may variably broaden the emitted beam. In some embodiments, the beam shaper 453 may be a liquid crystal beam shaper. As illustrated, the unbroadened emitted beam may have a first (small) illumination angle 410 and the broadened emitted beam may have a second (larger) illumination angle 411. The beams may share the same optical axis 454. FIG. 4 further illustrates also a near “off-axis” object 416 and a far “on-axis” object 415.

FIGS. 5A and 5B are flowcharts which illustrate how the methods described above may be performed iteratively. These methods may be performed for objects in any locations described above.

FIG. 5A outlines a method of detecting an object using a proximity sensor. In step 501, beam projection and detection are initiated. A beam may be projected by an emitter or any other piece of equipment, and as described above, the beam may be conical. In this step, the beam may be unbroadened, and in some embodiments, the angle of the beam cone may be about 2 to 3 degrees. With reference to FIG. 3, the beam may be represented by narrow beam 310. The object may reflect some, all, or none of the beam back to a receiver, and a first SNR may be calculated based on the received signal.

In step 502, the beam may be broadened using the methods and hardware described above or using any other methods and hardware known in the art. The beam may be broadened by a small increment, for example by one degree. In this step, the object may reflect some, all, or none of the beam back to the receiver and a second SNR may be calculated based on the received signal.

In step 503, the first SNR may be compared to the second SNR to determine which is greater. As described above, a higher SNR may indicate that the reflected signal makes up a greater part of the received signal and the object occupies a larger portion of a cross-section of the emitted beam, while a lower SNR may indicate that the reflected signal makes up a smaller part of the received signal and the object occupies a smaller portion of a cross-section of the emitted beam. The measurement is mainly relative since different objects may have different reflectivities at used wavelengths.

If the second SNR is greater than the first SNR, the method may return to step 502. If the second SNR is smaller than the first SNR, the method may advance to step 504.

In the method returns to step 502, steps 502 and 503 may be repeated any number of times. In each increment, the currently calculated SNR will be compared to the immediately preceding SNR. For example, a sixth SNR may be compared to a fifth SNR. Whenever the current SNR is smaller than the immediately preceding SNR, the method may advance to step 504.

In step 504, the beam may be narrowed using the methods and hardware described above or using any other methods and hardware known in the art. Narrowing the beam may comprise broadening the original beam to a lesser degree than the degree to which the beam was broadened in the preceding step. The beam may be narrowed by a small increment, for example by one degree. In this step, the object may reflect some, all, or none of the beam back to the receiver and a new SNR may be calculated based on the received signal.

In step 505, the new SNR may be compared to the immediately preceding SNR to determine which is greater. If the new SNR is greater than the preceding SNR, the method may return to step 504. If the new SNR is smaller than the preceding SNR, the method may conclude.

In the method returns to step 502, steps 504 and 505 may be repeated any number of times. In each increment, the currently calculated SNR will be compared to the immediately preceding SNR. For example, a sixth SNR may be compared to a fifth SNR. Whenever the current SNR is smaller than the immediately preceding SNR, the method may conclude.

Conclusion of the method may indicate that the largest possible SNR for the given object and sensor has been identified. This may indicate the point at which the most accurate object detection or recording may be performed.

FIG. 5B outlines further analysis which may be performed when the maximum SNR is identified to accomplish object location. In FIG. 5B, steps 501-505 are similar to the corresponding steps in FIG. 5A. Step 506 represents object location. In step 506, the beam angle corresponding to the maximized SNR may be identified. Further, the identification strength of the object, or the amount of the emitted beam which the object reflects when the SNR is maximized, may be measured. Based on these values, the approximate location of the object may be estimated. The estimated location may comprise an annular conical or annular slit shaped region extending outward from the sensor. Accordingly, in some embodiments, it may not be possible to differentiate between an on-axis close target and an off-axis far target. Further analysis may be required to determine the location of the object with more precision. For example, a grid of laser points may be used (see hereafter).

Further detailed embodiments of the method and systems described above will now be outlined.

In a first embodiment, a liquid crystal beam shaper may be used to control and optimize A—the width of the scene of illumination (the analogy of the variable “field of view”) as well as B— the level of illumination. A simple feedback system (photo detector, camera image sensor, etc.) can be used to adjust the angular range of illumination that will, in the same time, allow also the control of the level of illumination (an alternative way of dimming to optimize the signal capture).

This can be done along with a white (broad-band) light or narrow band illumination source.

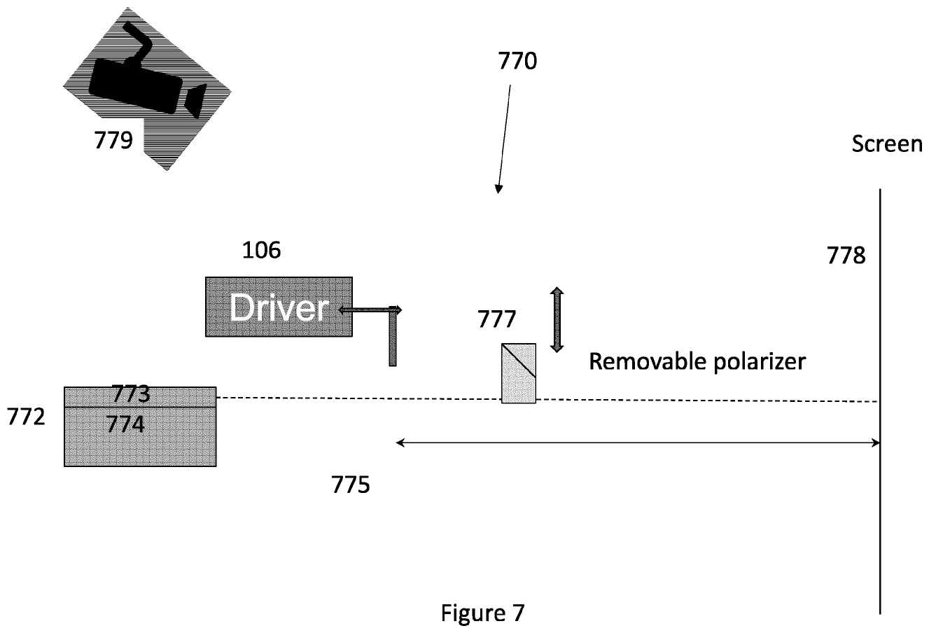

In a second embodiment a dynamic liquid crystal beam shaper may be used to perform a dynamic scan of the beam broadening angle, for example going from a large 55 deg (always measured at Full Width at Half of Maximum, FWHM) to a narrow 2 deg beam to help estimate approximate size of an object as well as its distance from the optical axis of illumination. Some embodiments may use an accompanying dimming or intensity change. FIG. 6 is a flowchart illustrating this method.

In step 631, the original light source and any corresponding “primary optics” can provide rather narrow beam to start with (e.g., 2 deg.). In step 632, one of the beam broadening components may be used to obtain a very large illumination angle at the beginning and start detecting the back scattered (and reflected) light. The beam broadening component may be calibrated in advance so that it is known how much light goes in which direction. Thus, the detected/recorded signal would represent objects in the entire illumination zone (field of view). If the beam is narrowed, then the field of illumination exposes more and more objects positioned close to the optical axis and, in some extend, to not detect anymore objects which are off-axis. In step 633, the recorded signal may be analyzed, for example by determining an SNR. In step 634, it may be determined whether or not the signal is sufficient to perform the desired calculations based on the analysis. The desired calculations may comprise determining a size or location of the object. If the signal is sufficient as indicated by step 635, the size of the object and the distance of the object from the optical axis may be determined. If the signal is not sufficient, as indicated by step 636, the method may return to step 632 and cycle through again. This dynamic scanning will give the information about the presence of objects in different solid angles around the same optical axis. Also, as the reflection/back scattering light's intensity will be also defined by the distance of the object with respect to the illumination/recording module. The dynamic scan of the illumination angle will thus provide information about the proximity of objects as well as their relative sizes and positions with respect to the optical axis (without the capability of identifying it is on the left or on the right of the optical axis).

Here also, the adjustment of the illumination power (or intensity) may be used to optimize the detection or recording. For example, it may be necessary to increase the intensity of the light source if the object is too far (to have enough reflected light). However, there may be also need to adjust the light intensity down when the object is too close (to avoid the detection saturation). A similar effect can be obtained by broadening the light divergence angle.

Systems and Methods Using a Diffracted Beam

As discussed above, the present disclosure also relates to object location systems and methods for locating and characterizing objects which use diffracted beams. Object location systems according to the present disclosure may include proximity sensors, image recording and liquid crystal devices. Methods of locating objects may make use of these systems and may have practical applications in a variety of fields.

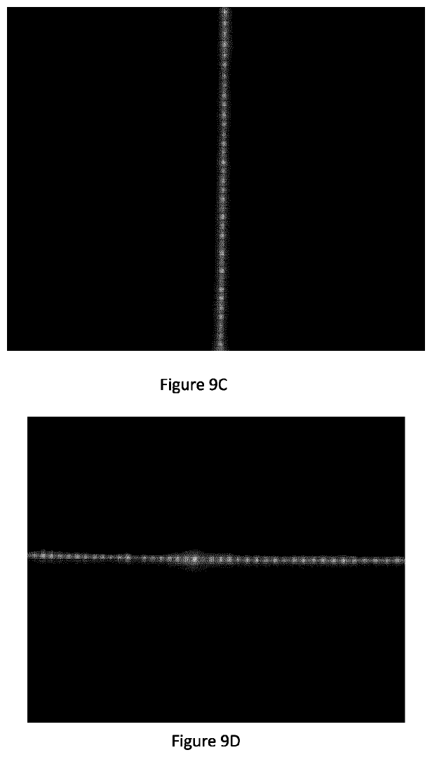

In general, the use of beam shaping devices with periodic internal structures (providing periodic modulation of optical refractive indexes) can generate diffraction patterns when we use a narrow band light source. FIG. 9A shows the picture (recorded on a white screen) of the original beam shape of such a source. The activation of the beam shaping device with periodic structures, such as those illustrated in FIGS. 1 and 2, can generate the light intensity distribution (2D grid) described in the FIG. 9B. The distance between spots (the grid size on the photo) is defined by the angle of diffraction for the specific periodicity of the beam shaping device. For the same angle, the grid size will be different at different (from the emitter) distances. The number of electrodes of that device may be split into different groups, allowing us the generation of various periods of refractive index. This, in turn, will allow us generating different diffraction angles and thus adjusting the grid size at a given distance.

FIG. 7 is a schematic representation of an object location system 770 with an experimental setup, which provides periodic modulation of a beam. The object location system 770 may include a proximity sensor 772 and may be configured to determine the location of objects within the field of view of the proximity sensor 772. The field of view may be considered the region of space in which the proximity sensor 772 is capable of detecting objects. In some embodiments, the object location system 770 may determine additional information about an object, such as its size or morphology.

The proximity sensor 772 may be any type of proximity sensor known in the art. In general, the proximity sensor 772 may include a light source 773 and a receiver 774. The light source 773 may be configured to emit either broad band light (e.g. LED/Phosphore) or narrow band light (e.g. infrared LED or diode laser). The diffraction pattern appearance can be improved by using a coherent light source. In some embodiments, the light source 773 may emit light in pulses at a certain frequency or pattern of frequencies. The receiver 774 may capture a received signal. The received signal may comprise background light from the environment in which the proximity sensor 772 is located. If an object is located in the path of the emitted signal, the received signal may also comprise light emitted by the light source 773 that is reflected from the object. The receiver 774 or a connected processor may differentiate the reflected signal from the background noise, for example, by identifying the frequency of pulses present in the reflected signal.

The receiver 774 or a connected processor may acquire an image of the reflected light. The light may reflect off the object in a grid pattern based on the pattern in which it has been diffracted. The grid will be deformed for objects having non flat surfaces.

The object location system 770 may further include one or more liquid crystal devices 775. FIGS. 1 and 2 illustrate exemplary liquid crystal devices and are described in detail above. A liquid crystal device 775 may be similar to what is shown in FIG. 1 or 2, or may be a combination of those devices or any type of liquid crystal device known in the art. The liquid crystal device may be positioned in front of the light source 773, such that light emitted by the light source 773 passes through the liquid crystal device 775. When no voltage is applied to the liquid crystal device 775, light may pass through the device 775 without being affected, as shown in FIG. 9A. When a voltage is applied to the liquid crystal device 775, light which passes through the device 775 may be diffracted. The diffracted light may form a grid pattern as shown in FIG. 9B. In some embodiments, the voltage may be applied by a driver 106.

In some embodiments, the object location system 770 may include more than one group of patterned electrodes within each liquid crystal layer (or cell) or a combination of many liquid crystal devices 775. Each of the devices 775 may produce a different diffraction pattern, or in other words, a grid with a different pitch. The liquid crystal devices 775 may be disposed in series, such that light from the light source 772 passes through all the liquid crystal devices 775. The devices 775 may be controlled such that no more than one device 775 has a voltage applied at a time. The control may be preformed by various types of controller, processor, or other hardware and software.

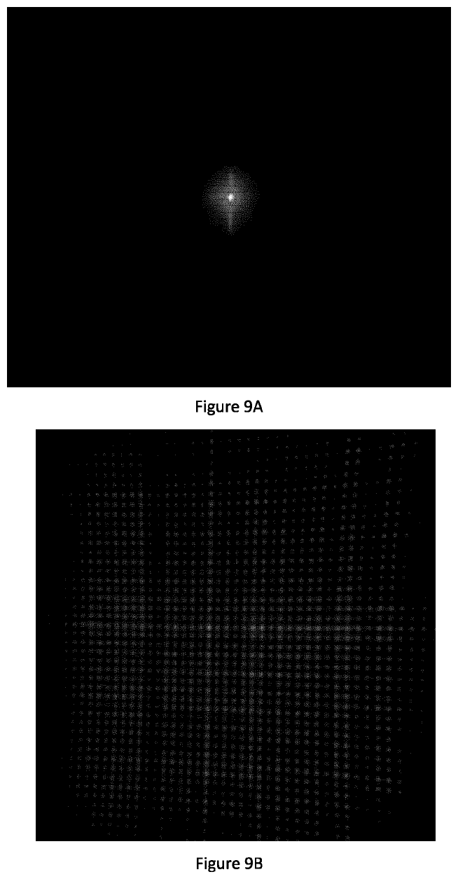

In some embodiments, the object location system 770 may include a single liquid crystal device 775 capable of producing multiple diffraction patterns. FIGS. 8A and 8B illustrate components of two such liquid crystal devices. As discussed above with respect to FIGS. 1 and 2, a liquid crystal device may include numerous electrodes. As shown in FIG. 8A, each electrode 881 may be individually controlled to have a positive charge, a negative charge, or no charge. Means for controlling electrodes individually are well known in the art. In such devices, different electrodes may be activated to produce different diffraction patterns. Charging all of the electrodes 881 may produce the tightest pitch (for the refractive index modulation), while leaving some electrodes 881 uncharged may produce a broader pitch. As shown in FIG. 8B, groups 882 of electrodes 881 may be controlled together. In this particular example, every sixth electrode 881 is connected, such that every sixth electrode 881 must have the same charge. However, one skilled in the art will readily recognize that the electrodes 881 could be connected in any pattern. In such devices, different patterns of electrodes may be activated to produce different diffraction patterns.

In some embodiments, the liquid crystal device 775 may include a series of horizontal electrodes (not illustrated) and a series of vertical electrodes (not illustrated). The electrodes may be generally finger shaped, or may have any other shape known in the art. The horizontal electrodes may be activated to produce a vertical line of dots of light, as shown in FIG. 9C. The vertical electrodes may be activated to produce a horizontal line of dots of light, as shown in FIG. 9D. The horizontal and vertical electrodes may be activated together to produce a grid of dots of light as shown in FIG. 9B. In some embodiments, other means may be used to produce lines or grids of dots.

In addition to the elements shown in FIG. 7, the object location system 770 may include a controller, processor, and/or other computer element. These elements may control the proximity detector 772 and/or the liquid crystal device 775. In some embodiments, these elements may collect and analyze data captured by the proximity detector 772. For example, they may calculate a signal-to-noise ratio based on the background light and the reflected signal captured by the proximity detector 772. In some embodiments, the liquid crystal device may be controlled based on these calculations.

In addition to the elements described above, FIG. 7 shows a photo camera 779 and a screen 778. In general, these elements are not part of the object location system 770, but they may be used to analyze the grid patterned light created by the object location system 770.

As discussed above, FIGS. 9A-9D illustrate light patterns which may be produced by an object location system according to the present disclosure. FIG. 9A shows a single point of light, which may be produced by turning on the light source while not applying voltage to any liquid crystal device. FIG. 9B shows a grid of light which may be produced by applying a voltage to a liquid crystal device in front of the light source. The pitch of the grid pattern may be specific to the liquid crystal device. FIGS. 9C and 9D show a vertical beam of light with bright points and a horizontal beam of light with bright points, respectively.

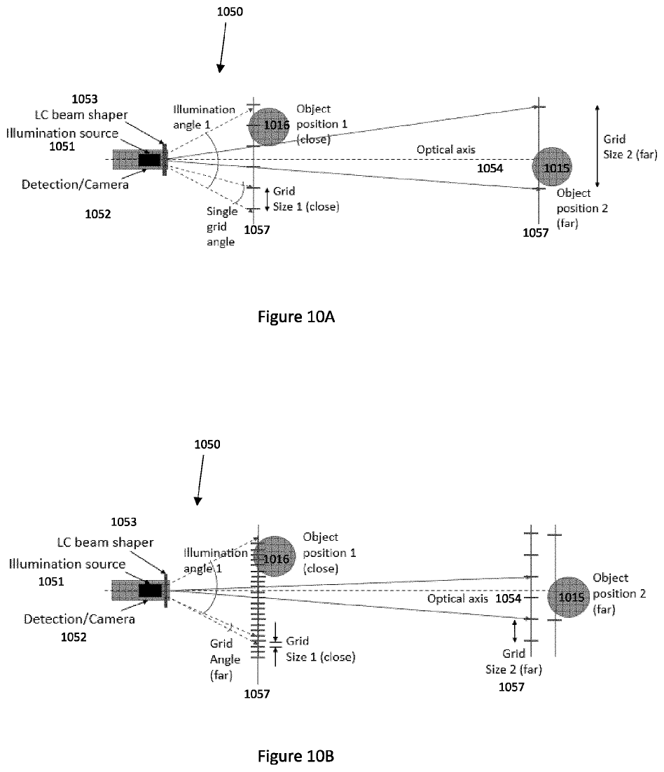

FIGS. 10A and 10B illustrate an object location and characterization system 1050 which may use diffracted light as described above. It should be recognized that this system 1050 is similar to the system 450 illustrated in FIG. 4, but uses diffracted light instead of a broadened beam. The system 1050 may include hardware which may function as the emitter/receiver or camera described above. An illumination source 1051 may emit a signal, which may comprise pulses of light or infrared radiation. As shown, the light may be emitted in a conical zone having an optical axis 1054. A detector/camera 1052 may receive reflected light and other background light. The illumination source 1051 and the detector/camera 1052 may be connected to a processor (not shown) or other hardware which may analyse the grids (form, shape, intensity, etc.) and/or may calculate SNRs based on the emitted and received signals. A beam shaper 1053 may be connected to the illumination source 1051, such that the beam shaper 1053 may broaden the emitted beam. In some embodiments, the beam shaper 1053 may be a liquid crystal beam shaper which diffracts the beam. As illustrated in FIG. 10A, the emitted beam may be diffracted into a pattern 1057 with a first pitch. This pitch may allow the object location system 1050 to detect a near object 1016, but not a far object 1015. As illustrated in FIG. 10B, the emitted beam may be diffracted into a pattern 1057 at a second pitch which is smaller than the first pitch. This pattern 1057 with a smaller pitch may allow the object location system 1050 to detect both a near object 1016 and a far object 1015. An optimal pitch may be generated for each distance to improve the detection, including the surface profile of the object. The configurations shown in FIGS. 10A and 10B may use the same beam shaper 1053 or different beam shapers 1053.

The present disclosure is further related to methods of locating objects using proximity sensors and liquid crystal devices. In some embodiments, methods according to the present disclosure may use object location systems as illustrated in FIGS. 7 and 10A-10B. The following exemplary methods are directed towards specific examples. One skilled in the art will recognize that the steps in these methods could be performed in other applications; such modifications are within the scope of the present disclosure.

Methods according to the present disclosure may be used to detect and analyze an object. A light signal may be projected from a light source. The signal may comprise a series of pulses of light at a particular frequency. The signal may be unchanged, i.e. not diffracted or polarized. A receiver may be used to detect whether or not the light signal is reflected. The receiver may receive both background light and reflected light, and the received light may be analyzed to determine a signal to noise ratio or other measure indicating the amount of reflected light present. If the amount of reflected light is above a threshold, this may indicate that an object is present.

If an object is present, a liquid crystal device may be used to diffract the light signal to produce a grid pattern of light. The object may reflect the points of light in the grid which are projected onto it, while not reflecting the other points of light. The location of the object within the grid may be determined based on the points which it reflects.

In some embodiments, further steps may be taken to collect additional information about the object. The device can produce a single vertical or horizontal line of light with strong bright points. These points may allow more specific information to be gathered about a small object or a particular region of a larger object. For another example, voltage may be applied to a second liquid crystal device and removed from the first liquid crystal device. This may allow the distance of the object from the proximity sensor to be determined more specifically and may allow the morphology of some objects to be determined.

Methods according to the present disclosure may be used in autonomous cars, security systems, automatic appliances and other smart home applications, recording applications, and numerous other applications. The steps described above may be modified as necessary to accommodate the particular situations.

In some methods, illumination grids may be used to recover the 3D information (by the deformation of the grid lines) or for the corrections of deformations of the image recorded. The characteristic size of the unit (distance between spot lines or the diagonal of a rectangle, etc.) must be large enough to be captured by the camera, but, at the same time, small enough to reveal the spatial depth variations of the object. Naturally, this size must be different for close or far positions of the same object, as shown in FIGS. 10A-10B. For example, the grid spacing (angles) 1057, generated for the close object 1016, will not be acceptable for the far object 1015. Thus, the beam shaping element can be used to continuously change the angle to adapt the “unit cell size” of the grid to the distance and to the size of the object.

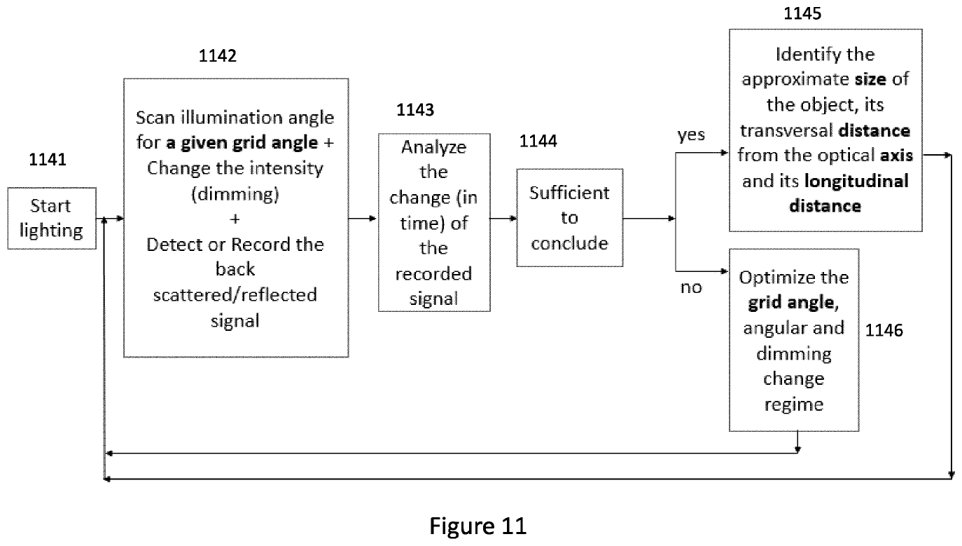

FIG. 11 is a flowchart illustrating a method for identifying the size and location of an object using an illumination grid. In step 1141, the original light source and any corresponding “primary optics” can provide a beam. In step 1142, one of the beam broadening/diffracting components may be used to produce an illumination grid and start detecting or recording the image of the back scattered (and reflected) light. In step 1143, the recorded signal may be analyzed, for example by determining an SNR. In step 1144, it may be determined whether or not signal is sufficient to perform the desired calculations based on the analysis. The desired calculations may comprise determining a size or location or the shape of the object. If the signal is sufficient as indicated by step 1145, the size of the object and the distance of the object from the optical axis may be determined. If the signal is not sufficient, as indicated by step 1146, the method may return to step 1142 and cycle through again, changing the grid angle. In some embodiments, the brightness/dimming may also be changed. This dynamic scanning will give information about the presence of objects in different solid angles around the same optical axis.

In some embodiments, a liquid crystal beam shaper may be used along with a relatively narrow band illumination source to generate an illumination grid, to control the size of the unit element in the illumination grid. Such embodiments may be used for applications such as the corrections of distortions of cameras (e.g., panoramic or fish-eye cameras), identification of the distance of objects (by the distance of spots on the object, similar to Moiré interferometry, along with the known unit cell size of the grid that will be generated) and, the evaluation of the 3D profile of the object.

In some embodiments, a liquid crystal beam shaper may be used along with an illumination source to generate a continuously variable illumination angle (grid or just illumination) that is accompanied with a continuous detection of the back scattered signal. The detection of the back scattered signal will be affected by the position and size of objects (in the scene). For example, if, for a narrow-angle illumination, the back scattered and detected signal is weak or absent then that would mean that there is no object within the illuminated solid angle. Then when increasing the divergence angle the detection of a signal would mean an appearance of an object within a specific solid angle. The continuous process of broadening and detection might identify also the size of the object.

In some embodiments, a liquid crystal beam shaper and steerer, which may include components like those presented in FIG. 2, may be used along with an appropriate illumination source to generate a continuously variable illumination angle (with or without the grid structure) and illumination direction that is accompanied with a continuous detection of the back scattered signal. The use of a steering option may eliminate the ambiguity of the object position with respect to the axis of observation in the previous embodiments. Also, the steering option may partially eliminate the need in large broadening angle, so low power illumination sources can be used. The detection of the back scattered signal will be affected by the position and size of objects (in the scene).

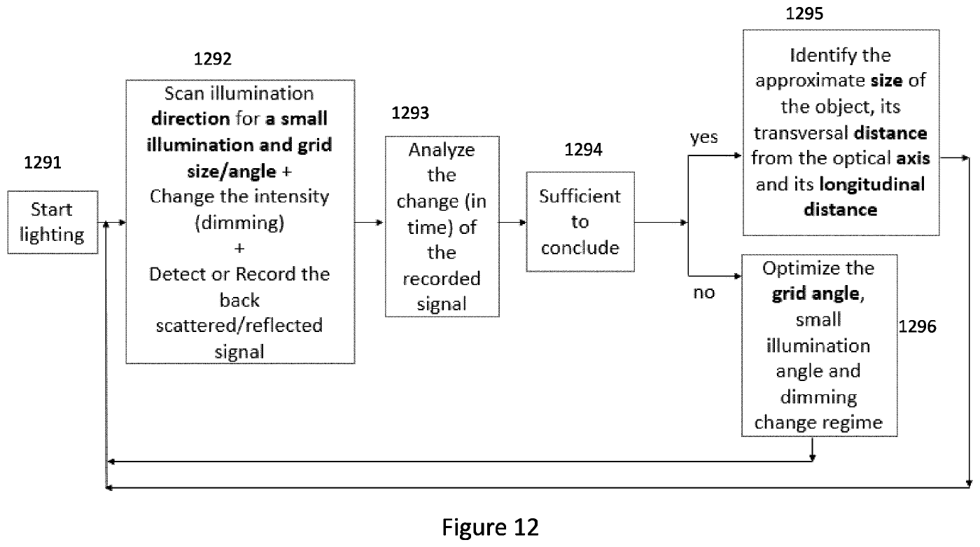

FIG. 12 is a flowchart illustrating a method for identifying the size and location of an object using an illumination grid and steering. In step 1291, the original light source and any corresponding “primary optics” can provide a beam. In step 1292, one of the beam broadening/diffracting components may be used to produce an illumination grid and start detecting the back scattered (and reflected) light. A steering component may be used to set an illumination direction to a given small illumination angle. In step 1293, the recorded signal may be analyzed, for example by determining an SNR. In step 1294, it may be determined whether or not signal is sufficient to perform the desired calculations based on the analysis. The desired calculations may comprise determining a size or location or shape of the object. If the signal is sufficient as indicated by step 1295, the size of the object and the distance of the object from the optical axis may be determined. If the signal is not sufficient, as indicated by step 1296, the method may return to step 1292 and cycle through again, changing the grid angle and/or the small illumination (steering) angle. In some embodiments, the brightness/dimming may also be changed. This dynamic scanning will give the information about the presence of objects in different solid angles around the same optical axis.

1. A detection device comprising:
a light source for projecting a beam of light within a target region having an initial beam divergence;
a light detector for receiving light reflected from an object within the target region and providing a detection signal;
a liquid crystal beam shaping element having an input control signal defining a modulation of the light source beam to provide a controllable greater divergence in said beam of light within said target region; and
a controller responsive to said detection signal for adjusting said input control signal to detect and analyze objects and positions of said objects with an improved signal-to-noise ratio.

2. The detection device of claim 1, wherein the liquid crystal beam shaping element comprises a liquid crystal layer disposed between two substrates and two or more independent electrodes disposed on one of the substrates.

3. The detection device of claim 2, wherein the electrodes are configured to provide a spatially variable electric field.

4. The detection device of claim 1, wherein the initial beam divergence is less than 10 degrees.

5. The detection device of claim 1, wherein the beam divergence is between 2 degrees and 50 degrees.

6. The detection device of claim 1, configured to detect a distance of the object from the detection device.

7. The detection device of claim 1, wherein the light source is configured to project the beam of light in a series of pulses.

8. The detection device of claim 6, wherein the light detector is configured to use a bandpass filter to distinguish the detection signal from a noise signal.

9. The detection device of claim 1, wherein the liquid crystal beam shaping element is configured to perform at least one of the following: symmetric broadening, asymmetric light stretching, diffraction and beam steering.

10. An automatic controller for an appliance comprising one or more detection devices according to claim 1.

11. A method of performing proximity detection using a proximity sensor, the method comprising:
projecting a beam of light within a target region, the beam having an initial beam divergence and angle of projection;
receiving light reflected from an object within the target region;
determining a first signal-to-noise ratio;
dynamically manipulating the beam of light;
determining a second signal-to-noise ratio; and
determining a distance of the object from the proximity sensor.

12. The method of claim 11, wherein manipulating the beam of light comprises broadening the beam divergence of the beam of light.

13. The method of claim 11, wherein manipulating the beam of light comprises changing the angle of projection of the beam of light.

14. The method of claim 11, wherein manipulating the beam of light comprises using a liquid crystal element.

15. The method of claim 12, further comprising eliminating noise from the detected signals.

16. A method of determining a location and/or a shape of an object, the method comprising:
projecting a light signal with narrow spectral band;
diffracting the light signal using a liquid crystal device to produce a grid pattern;
acquiring an image of the grid pattern reflected by the object; and
determining the location and/or a shape of the object from said grid pattern reflected by the object.

17. The method of claim 16, wherein the grid pattern extends in a single direction.

18. The method of claim 16, wherein the grid pattern extends in two directions in a single plane.

19. The method of claim 16, further comprising configuring the liquid crystal device to control a pitch of the grid pattern.

20. The method of claim 19, wherein controlling a pitch of the grid pattern comprises producing a first grid pattern with a first pitch and a second grid pattern with a second pitch.

21. The method of claim 19, wherein controlling a pitch of the grid pattern comprises dynamically varying the pitch.

22. The method of claim 16, wherein the light signal comprises pulses at a given frequency.

23. The method of claim 16, further comprising controlling the liquid crystal device based on the acquired image of the reflected light.
